(19) United States
(12) Patent Application Publication
(10) Pub. No.: US 2026/0160225 A1
(43) Pub. Date: Jun. 11, 2026

(54) INTERNAL COMBUSTION ENGINE

(71) Applicant: TOYOTA JIDOSHA KABUSHIKI KAISHA, Toyota-shi (JP)

(72) Inventors: Masami ISHIKAWA, Aichi-gun (JP); Yutai KITAGO, Toyoake-shi (JP); Satoshi SABA, Anjo-shi (JP); Yuya ITO, Toyota-shi (JP); Takashi KOBAYASHI, Toyota-shi (JP)

(73) Assignee: TOYOTA JIDOSHA KABUSHIKI KAISHA, Toyota-shi (JP)

(21) Appl. No.: 19/412,219

(22) Filed: Dec. 8, 2025

(30) Foreign Application Priority Data
Dec. 10, 2024 (JP) 2024-215295

(51) Int. Cl. F02M 35/10; F01M 13/00

(52) U.S. Cl. CPC F02M 35/10157; F01M 13/00

(57) ABSTRACT

An internal combustion engine includes an internal combustion engine body, a turbocharger connected to the internal combustion engine body, and an intake device connected to the internal combustion engine body. The intake device includes a first flow path that introduces fresh air into the turbocharger, and a second flow path through which blow-by gas flows from the internal combustion engine body. The second flow path extends adjacent to the first flow path and joins the first flow path at an end of the second flow path from obliquely rearward with respect to a direction in which the fresh air flows. An inner space is provided inside a partition wall that separates the first flow path and the second flow path adjacent to each other.

### CROSS-REFERENCE TO RELATED APPLICATION

This application is based upon and claims the benefit of priority of the prior Japanese Patent Application No. 2024-215295, filed on Dec. 10, 2024, the entire contents of which are incorporated herein by reference.

### TECHNICAL FIELD

The present disclosure relates to an internal combustion engine.

### BACKGROUND

Regarding an internal combustion engine, for example, Japanese Unexamined Patent Application Publication No. 2024-41416 describes that blow-by gas is introduced into an intake path connected to a turbocharger via an introduction path.

When the blow-by gas flows into the intake path from the introduction path, the blow-by gas is rapidly cooled by the low-temperature fresh air flowing in the intake path. Therefore, the moisture in the blow-by gas is crystallized to produce a large number of ice crystals. The ice crystals might flow into a turbocharger downstream to damage an impeller or the like.

### SUMMARY

It is therefore an object of the present disclosure to provide an internal combustion engine capable of suppressing damage to a turbocharger.

An internal combustion engine of the present disclosure includes: an internal combustion engine body; a turbocharger connected to the internal combustion engine body; and an intake device connected to the internal combustion engine body, wherein the intake device includes: a first flow path that introduces fresh air into the turbocharger; and a second flow path through which blow-by gas flows from the internal combustion engine body, the second flow path extends adjacent to the first flow path and joins the first flow path at an end of the second flow path from obliquely rearward with respect to a direction in which the fresh air flows, and an inner space is provided inside a partition wall that separates the first flow path and the second flow path adjacent to each other.

In the above internal combustion engine, the partition wall may include a curved surface that bulges toward the second flow path and curves toward the first flow path at the end.

In the above internal combustion engine, the second flow path may include a connection portion connected to a vent for the blow-by gas, the vent being provided in a head cover of the internal combustion engine, and the connection portion may include an orifice.

In the above internal combustion engine, a heat insulator provided in the inner space may be included.

In the above internal combustion engine, a heating unit provided in the inner space and configured to heat the second flow path may be included.

### BRIEF DESCRIPTION OF THE DRAWINGS

FIG. 1 is a view illustrating a schematic configuration of an engine;

FIG. 2 is a perspective view illustrating an intake duct attached to a head cover;

FIG. 3 is a view illustrating a cross section of the intake duct taken along line A-A in FIG. 2;

FIG. 4 is a view illustrating a cross section of the intake duct taken along line B-B in FIG. 3;

FIG. 5A is a view exemplifying a cross section of an intake duct in which a heat insulator is provided in an inner space in a partition wall; and

FIG. 5B is a view illustrating a cross section of the intake duct in which the heating unit is provided in the inner space inside the partition wall.

### DETAILED DESCRIPTION

### Schematic Configuration of Engine

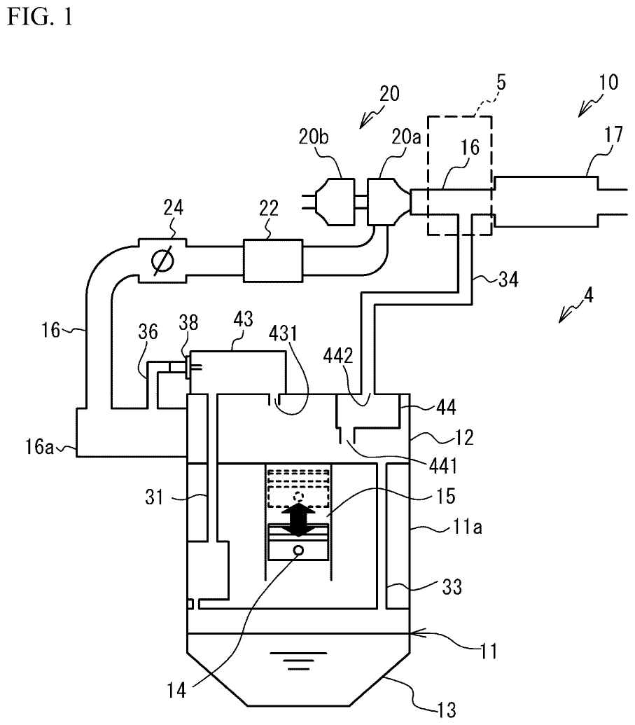

FIG. 1 is a view illustrating a schematic configuration of an engine 10. The engine 10 is a spark ignition type four cylinder gasoline engine, and is an example of an internal combustion engine, but is not limited thereto. The engine 10 may be an engine other than the four cylinder engine, and may be an engine of another type such as a compression ignition diesel engine.

The engine 10 includes an internal combustion engine body 11, a head cover 12, a crankcase 13, a piston 14, a combustion chamber 15, an intake path 16, a turbocharger 20, an intercooler 22, and a throttle valve 24. The internal combustion engine body 11 includes a cylinder block 11a, the head cover 12 provided above the cylinder block 11a, and the crankcase 13 provided below the cylinder block 11a. The piston 14 reciprocates in the combustion chamber 15 of the cylinder block 11a. The intake path 16 is connected to cylinders of the internal combustion engine body 11 via an intake manifold 16a.

An air cleaner 17 is attached to the intake path 16 in the vicinity of an inlet portion of the intake path 16. A compressor 20a of the turbocharger 20 is disposed downstream of the air cleaner 17 in the intake path 16 and compresses intake air. The compressor 20a is integrally connected to a turbine 20b disposed in the exhaust path via a connecting shaft.

The intercooler 22 is disposed downstream of the compressor 20a in the intake path 16 and cools the supercharged air. The throttle valve 24 which is electrically controlled is provided downstream of the intercooler 22. The intake manifold 16a is disposed downstream of the throttle valve 24.

A blow-by gas guide path 31 is provided in the cylinder block 11a and the head cover 12. The blow-by gas guide path 31 is formed through the cylinder block 11a and the head cover 12, and connects the crankcase 13 to a main separator 43 so as to lead the blow-by gas present in the crankcase 13 to the main separator 43. The main separator 43 is provided with a communication port 431, which communicates the head cover 12 with the main separator 43 and leads the blow-by gas existing in the internal space of the head cover 12 to the main separator 43.

The blow-by gas is led to the main separator 43 via the blow-by gas guide path 31, and the blow-by gas from which oil mist has been separated by the main separator 43 is recirculated to the intake manifold 16a by a blow-by gas recirculation path 36 that communicate the main separator 43 and the intake manifold 16a.

A positive crankcase ventilation (PCV) valve 38 is provided at an end portion of the blow-by gas recirculation path 36 on the main separator 43 side. The PCV valve 38 is configured as differential pressure operated valves that are operated in response to a differential pressure between the internal space of the head cover 12 on the upstream side of the PCV valve 38 and the intake manifold 16a on the downstream side thereof. The PCV valve 38 adjusts the flow rate of the blow-by gas that flows back to the intake manifold 16a and prevents the blow-by gas from flowing back to the internal space of the head cover 12.

A fresh air introduction path 34 is provided for communicating the internal space of the head cover 12 with the intake path 16 on the upstream side of the compressor 20a and on the downstream side of the air cleaner 17. More specifically, the fresh air introduction path 34 communicates the intake path 16 with an atmosphere-side separator 44. The atmosphere-side separator 44 is provided in the head cover 12 and includes a first communication port 441 and a second communication port 442. The first communication port 441 communicates with the inside of the head cover 12. The second communication port 442 communicates with the fresh air introduction path 34. Further, a fresh air guide path 33 communicates the inside of the head cover 12 with the inside of the crankcase 13. Therefore, the fresh air passing through the intake path 16 is introduced into the internal space of the head cover 12 and the crankcase 13 through the fresh air introduction path 34, the atmosphere-side separator 44, and the fresh air guide path 33.

When the engine 10 is operated in the natural aspiration state, the pressure in the combustion chamber 15 and the intake manifold 16a on the downstream side of the throttle valve 24 becomes negative, and the pressure in the intake path 16 on the upstream side of the compressor 20a becomes the atmosphere pressure. Therefore, the fresh air flows into the fresh air introduction path 34, the atmosphere-side separator 44, the head cover 12, the fresh air guide path 33, and the crankcase 13. The blow-by gas is returned from the crankcase 13 and the head cover 12 to the intake manifold 16a through the main separator 43 and the blow-by gas recirculation path 36. In the main separator 43, an oil component is separated from the blow-by gas. In this way, the blow-by gas is supplied from the intake manifold 16a into the combustion chamber 15, and the blow-by gas is burned.

When the engine 10 is operated in the supercharging operation state, the pressure in the combustion chamber 15 and the intake manifold 16a on the downstream side of the compressor 20a becomes positive, and the pressure in the intake path 16 on the upstream side of the compressor 20a becomes negative. Therefore, the blow-by gas flows from the crankcase 13 through the blow-by gas guide path 31, the main separator 43, the head covers 12, the atmosphere-side separator 44, and the fresh air introduction path 34 in this order, and flows back to the intake path 16 on the upstream side of the compressor 20a. In the atmosphere-side separator 44, an oil component is separated from the blow-by gas. In this way, the blow-by gas is supplied into the combustion chamber 15 and is burned.

In the above configuration, the merging portion of the intake path 16 between the turbocharger 20 and the air cleaner 17 and the fresh air introduction path 34 is realized by an intake duct 5. The intake duct 5 is an example of an intake device of the internal combustion engine. The intake duct 5 and the turbocharger 20 are connected to the internal combustion engine body 11. The intake duct 5 will be described below.

### Configuration of Intake Duct

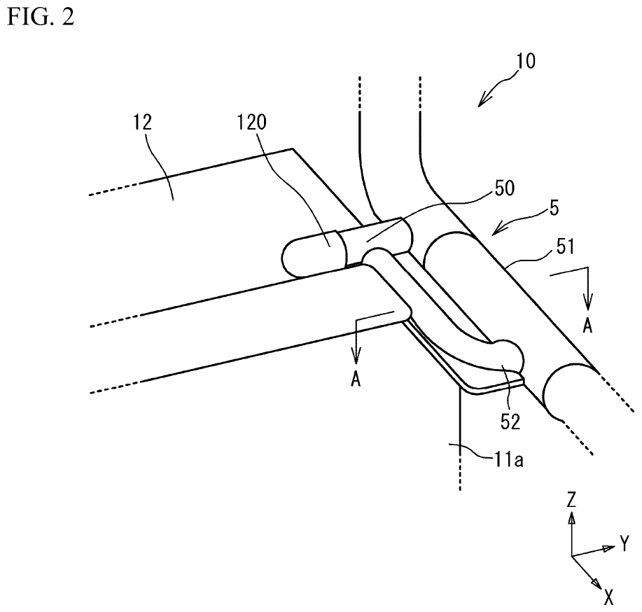

FIG. 2 is a perspective view illustrating the intake duct 5 attached to the head cover 12. In FIG. 2 and the subsequent drawings, an X direction, a Y direction, and a Z direction orthogonal to each other are illustrated.

The head cover 12 is made of, for example, plastic or aluminum, and is disposed on the upper portion of the cylinder block 11a. The shapes of the head cover 12 and the cylinder block 11a are schematically illustrated as rectangular parallelepiped shapes. A connector portion 120 connected to the intake duct 5 is provided near a corner of the head cover 12. The connector portion 120 corresponds to an end portion of the fresh air introduction path 34 on the head cover 12 side. The connector portion 120 is an example of a vent for blow-by gas.

The intake duct 5 is formed of, for example, steel, and includes a connection portion 50, a first pipe portion 51, and a second pipe portion 52. The connection portion 50 extends in a direction orthogonal to the direction in which the first pipe portion 51 and the second pipe portion 52 extend. The connection portion 50 is connected to a part of a side surface of the first pipe portion 51 and an end of the second pipe portion 52. The connection portion 50 is inserted into an opening of the connector portion 120 of the head cover 12. Thus, the fresh air introduction path 34 in the head cover 12 and the flow path in the intake duct 5 communicate with each other. A seal member such as an O-ring is provided between the connector portion 120 and the connection portion 50.

The upstream side of the first pipe portion 51 is connected to the air cleaner 17, and the downstream side of the first pipe portion 51 is connected to the compressor 20a of the turbocharger 20. The second pipe portion 52 is thinner than the first pipe portion 51 and is connected to the connection portion 50 and the first pipe portion 51. In the first pipe portion 51, intake air flows from the air cleaner 17 toward the compressor 20a. When the engine 10 is operated in the supercharging operation state, the blow-by gas from the crankcase 13 flows through the connection portion 50 and the second pipe portion 52 toward the first pipe portion 51.

In this way, the intake duct 5 connects the head cover 12, the air cleaner 17, and the compressor 20a. If the head cover 12 and the connection portion 50 of the intake duct 5 are connected via a hose, it is needed to provide, for example, a pressure sensor or the like in order to detect disconnection of the hose in accordance with a request of a legal regulation or the like. However, in this embodiment, since the connection portion 50 of the intake duct 5 is directly inserted into the connector portion 120 of the head cover 12 without using a hose, a disconnection detecting means such as a pressure sensor is not required.

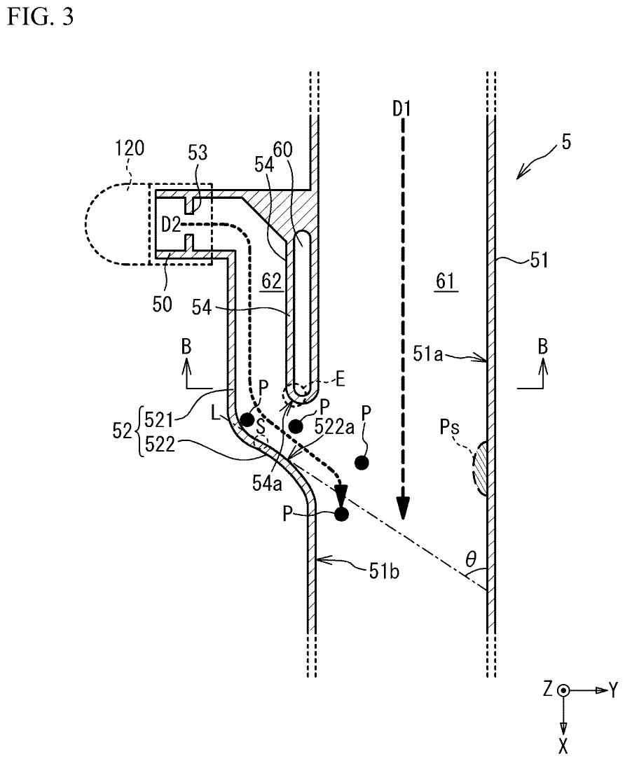

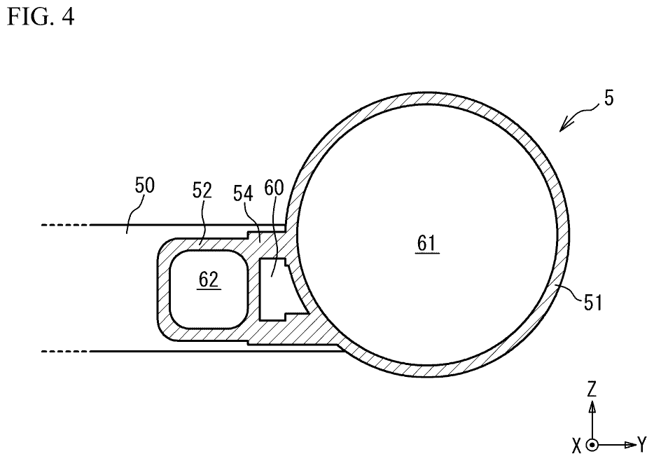

FIG. 3 is a view illustrating a cross section of the intake duct 5 taken along line A-A of FIG. 2. FIG. 4 is a view illustrating a cross section of the intake duct 5 taken along line B-B in FIG. 3. A first flow path 61 is provided inside the first pipe portion 51. A second flow path 62 is provided inside the second pipe portion 52 and the connection portion 50. The second pipe portion 52 includes an extension portion 521 extending in parallel to the first pipe portion 51 and an end portion 522 bent from the extension portion 521 toward the first pipe portion 51. The end portion 522 is an example of an end of the second flow path 62. The cross-sectional area of the first flow path 61 is larger than the cross-sectional area of the second flow path 62. As an example, the cross section of the first flow path 61 is substantially circular, and the cross section of the second flow path 62 is substantially rectangular. However, the cross sections are not limited to these, and other cross sectional shapes may be used.

The other end portion of the extending portion 521 is connected to the connection portion 50. The connection portion 50 is bent in a direction (Y direction) perpendicular to the extension portion 521 and is inserted into the connector portion 120. An orifice 53 for increasing the pressure loss of the blow-by gas is provided in the connection portion 50. The orifice 53 is formed integrally with the connection portion 50. When the engine 10 is operated in the naturally aspirated state, the orifice 53 acts to create a negative pressure inside the engine 10.

In this way, the orifice 53 is provided in the intake duct 5, not in the connector portion 120 of the head cover 12. Therefore, the maintenance of the orifice 53 is facilitated by removing the intake duct 5 from the head cover 12. Unlike the present example, the orifice 53 may be provided in the connector portion 120.

The first flow path 61 extends linearly in the X direction. The fresh air from the air cleaner 17 flows through the first flow path 61 as indicated by a reference sign D1 and is introduced into the turbocharger 20. The second flow path 62 is bent at a substantially right angle between the connection portion 50 and the second pipe portion 52, extends linearly in the X direction in the second pipe portion 52, and is bent obliquely with respect to the first flow path 61 at the end portion 522. The blow-by gas from the head cover 12 flows as indicated by a reference sign D2 and joins the fresh air in the first flow path 61. In this way, the second flow path 62 extends adjacent to the first flow path 61, and joins the first flow path 61 at the end portion 522 from the obliquely rearward with respect to the direction in which the fresh air flows in the first flow path 61. The cross-sectional area of the first flow path 61 is substantially constant on the upstream side and the downstream side of the merging position with the second flow path 62.

The first flow path 61 and the second flow path 62 are adjacent to each other in the Y direction. An inner space 60 extending in the X direction is provided inside a partition wall 54 that separates the first flow path 61 and the extension portion 521 of the second flow path 62. Therefore, the first flow path 61 and the second flow path 62 are thermally isolated from each other by the inner space 60. Therefore, compared to a case where the inner space 60 is not present, rapid cooling of the blow-by gas in the extension portion 521 by the fresh air in the first flow path 61 is suppressed. Therefore, the moisture in the blow-by gas is less likely to be crystallized. Therefore, the generation of ice crystals P in the second flow path 62 due to the cooling of the fresh air in the first flow path 61 is suppressed. The longer the length of the inner space 60 in the X direction is, the more difficult the blow-by gas is to be cooled, which is preferable.

Even if the water in the blow-by gas is crystallized to generate the ice crystals P, the second flow path 62 joins the first flow path 61 at the end portion 522 thereof from a direction oblique to the direction in which the fresh air flows. Therefore, most of the ice crystals P that have entered the first flow path 61 are likely to be carried to the downstream side together with the fresh air. In contrast, if the blow-by gas directly joins the first flow path 61 from the connection portion 50 in the direction orthogonal to the direction in which the fresh air flows, in the first flow path 61, a large number of the ice crystals P are likely to be generated by being gathered and grown on a wall surface 51a facing the opening of the second flow path 62.

However, in the present example, the second flow path 62 joins the first flow path 61 in a direction inclined with respect to the flow of fresh air in the first flow path 61. Therefore, even if small ice crystals P are generated together with fresh air, the ice crystals P are likely to be caused to flow to the compressor 20a side in accordance with the flow of fresh air in the first flow path 61. Therefore, unlike the above case, the ice crystals P are less likely to collect on the wall surface 51a of the first flow path 61. Therefore, the formation of a large ice crystal Ps due to the growth of a large number of the ice crystals P is suppressed, and as a result, damage to the compressor 20a is suppressed.

The angle θ at which the second flow path 62 joins the first flow path 61 is defined as, for example, an angle between a tangent line L passing through a reference point S of an inner wall 522a of the end portion 522 on the downstream side of the second flow path 62 and the wall surface 51a in the first flow path 61 in the cross section of FIG. 3. Here, the reference point S is, for example, the center position of the width of the second flow path 62 in the Y direction. The above effect is obtained when the angle θ is less than 90 degrees. However, the smaller the angle θ is, the less likely the ice crystals P reach the wall surface 51a of the first flow path 61, and the less likely large ice crystals Ps are generated, which is preferable.

In addition, in the end portion 522, a downstream end 54a of the partition wall 54 includes a curved surface E which bulges toward the second flow path 62 and curves toward the first flow path 61. Therefore, the blow-by gas flows into the first flow path 61 smoothly along the curved surface E, as compared with a case where the downstream end 54a is a wall surface having a square shape that is bent at a right angle toward the first flow path 61. Thus, resistance to the blow-by gas is reduced. Further, according to the curved surface E, the amount of blow-by gas that comes into contact with the partition wall 54 is increased as compared with the case where the downstream end 54a is a square wall surface as described above. Therefore, the inner space 60 suppresses the formation of the ice crystals P. The curved surface E may have an arc shape (for example, a fan-like arc shape with a central angle of 90 degrees).

The inner wall 522a of the end portion 522 of the second flow path 62 has a curved surface that is curved from the extension portion 521 toward the first flow path 61. For example, the inner wall 522a of the second flow path 62 is curved in an arc shape from the extension portion 521 toward the first flow path 61 so as to draw an S shape, and is smoothly connected to the inner wall of the first flow path 61. Therefore, the resistance when the blow-by gas enters the first flow path 61 from the second flow path 62 is reduced.

In contrast, if the inner wall 522a is a flat surface that forms an obtuse angle with the wall surface of the extension portion 521 and extends toward the first flow path 61, the blow-by gas diffuses at the corner between the extension portion 521 and the end portion 522, and thus receives a large resistance as compared with the curved surface. Therefore, the inner wall 522a of the end portion 522 has the curved surface curved toward the first flow path 61, and thus it is possible to suppress resistance received by the blow-by gas and to reduce pressure loss.

Thus, the intake duct 5 suppresses the formation of the ice crystals P from the moisture in the blow-by gas. Therefore, damage to the turbocharger 20 is suppressed. The inner wall of the second flow path 62 may be subjected to water repellent treatment so as to suppress the formation of the ice crystals P. The water repellent treatment may be Teflon (registered trademark) treatment, but is not limited thereto. Further, as in the following example, a heat insulator or a heating unit may be provided in the inner space 60.

### Other Embodiments

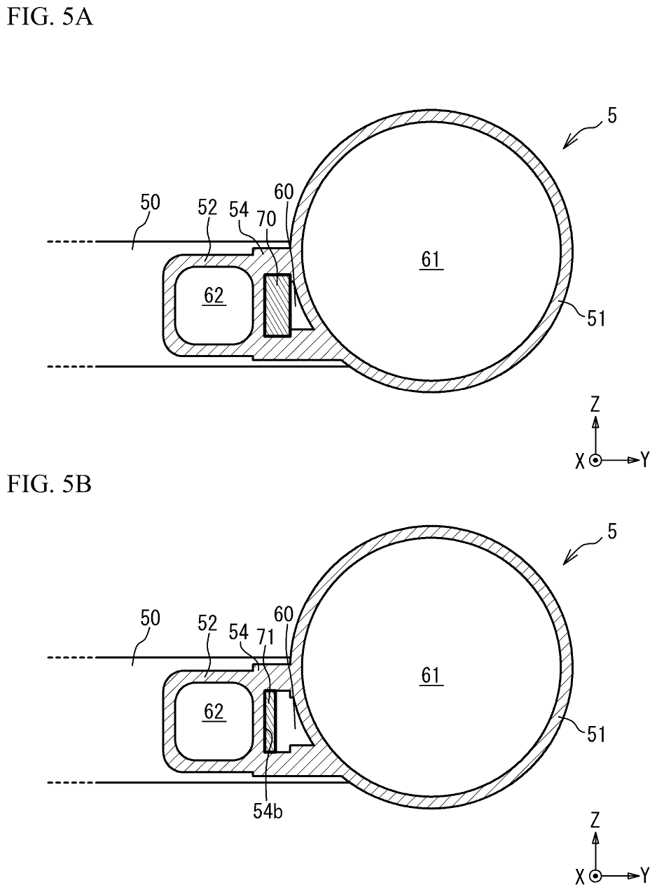

FIG. 5A is a view illustrating a cross section of the intake duct 5 in which a heat insulator 70 is provided in the inner space 60 in the partition wall 54. In FIG. 5A, the same reference numerals are given to the same components as those in FIG. 4, and the description thereof is omitted.

Examples of the heat insulator 70 include, but are not limited to, polyethylene terephthalate (PET), polyurethane foam, and glass fiber. Other materials may be used. According to the present example, the heat insulator 70 effectively blocks heat between the first flow path 61 and the second flow path 62, and thus, the generation of the ice crystals P in the second flow path 62 is effectively suppressed as compared to a case where the heat insulator 70 is not provided.

FIG. 5B is a view illustrating a cross section of the intake duct 5 in which a heating unit 71 is provided in the inner space 60 in the partition wall 54. In FIG. 5B, the same reference numerals are given to the same components as those in FIG. 4, and the description thereof is omitted.

The heating unit 71 may be a heater, but is not limited thereto. The heating unit 71 is provided in contact with an inside wall 54b on the second flow path 62 side, and heats the second flow path 62. According to the present example, since the second flow path 62 is heated by the heating unit 71, the generation of the ice crystals P in the second flow path 62 is effectively suppressed as compared with the case where the heating unit 71 is not provided.

In this example, the intake duct 5 is used as the intake device of the internal combustion engine, but it is not limited thereto. For example, the above-described configuration may be provided in an air cleaner hose extending from the air cleaner 17 instead of the intake duct 5.

Although some embodiments of the present disclosure have been described in detail, the present disclosure is not limited to the specific embodiments but may be varied or changed within the scope of the present disclosure as claimed.

What is claimed is:

1. An internal combustion engine comprising:
an internal combustion engine body;
a turbocharger connected to the internal combustion engine body; and
an intake device connected to the internal combustion engine body,
wherein
the intake device includes:
a first flow path that introduces fresh air into the turbocharger; and
a second flow path through which blow-by gas flows from the internal combustion engine body,
the second flow path extends adjacent to the first flow path and joins the first flow path at an end of the second flow path from obliquely rearward with respect to a direction in which the fresh air flows, and
an inner space is provided inside a partition wall that separates the first flow path and the second flow path adjacent to each other.

2. The internal combustion engine according to claim 1, wherein the partition wall includes a curved surface that bulges toward the second flow path and curves toward the first flow path at the end.

3. The internal combustion engine according to claim 1, wherein
the second flow path includes a connection portion connected to a vent for the blow-by gas, the vent being provided in a head cover of the internal combustion engine, and
the connection portion includes an orifice.

4. The internal combustion engine according to claim 1, further comprising a heat insulator provided in the inner space.

5. The internal combustion engine according to claim 1, further comprising a heating unit provided in the inner space and configured to heat the second flow path.
